(19) United States
(12) Patent Application Publication
(10) Pub. No.: US 2024/0128020 A1
(43) Pub. Date: Apr. 18, 2024

(54) METHOD FOR MANUFACTURING LAMINATED COIL COMPONENT, AND LAMINATED COIL COMPONENT

(71) Applicant: TDK CORPORATION, Tokyo (JP)

(72) Inventors: Yuya OSHIMA, Tokyo (JP); Junichi OTSUKA, Tokyo (JP); Yohei TADAKI, Tokyo (JP); Shinichi KONDO, Tokyo (JP); Koki ITO, Yurihonjo-city (JP); Yoji TOZAWA, Tokyo (JP); Shigeshi OSAWA, Yurihonjo-city (JP); Tsubasa OZAWA, Tokyo (JP); Makoto YOSHINO, Tokyo (JP)

(73) Assignee: TDK CORPORATION, Tokyo (JP)

(21) Appl. No.: 18/474,733

(22) Filed: Sep. 26, 2023

(30) Foreign Application Priority Data
Oct. 14, 2022 (JP) 2022-165626

(51) Int. Cl. H01F 41/12; H01F 17/00; H01F 27/32

(52) U.S. Cl. CPC H01F 41/12; H01F 17/0013; H01F 27/32

(57) ABSTRACT

In a method for manufacturing a laminated coil component, in which a laminated coil component is manufactured by laminating insulator sheets in order on which conductors having predetermined patterns are formed, the insulator sheets are laminated such that a distance in a lamination direction between a first lead-out conductor laminated first and a first coil conductor laminated next is larger than a distance in the lamination direction between a second lead-out conductor laminated last and a second coil conductor laminated immediately before the second lead-out conductor.

### CROSS REFERENCE TO RELATED APPLICATIONS

This application claims priority to Japanese Patent Application No. 2022-165626 filed on Oct. 14, 2022, the entire contents of which are incorporated by reference herein.

### TECHNICAL FIELD

The present invention relates to a method for manufacturing a laminated coil component, and a laminated coil component.

### BACKGROUND

A laminated coil component including an element body and external electrodes formed on surfaces of the element body is known (for example, Japanese Unexamined Patent Publication No. 2014-082280). In Japanese Unexamined Patent Publication No. 2014-082280, the laminated coil component includes a coil unit formed inside the element body; a lead-out conductor connected to the coil unit and exposed on one surface of the element body; and a lead-out conductor exposed on the other surface of the element body. The distance between the conductors is constant at all locations.

### SUMMARY

In the laminated coil component having the above-described configuration, when each of the lead-out conductors and the coil conductors are laminated, the coil conductors in the vicinity of one lead-out conductor may collapse due to the influence of the lead-out conductor (shift with respect to the coil conductors of other layers). Accordingly, the desired characteristics of the laminated coil component cannot be obtained, which is a problem.

An object of one aspect of the present invention is to provide a method for manufacturing a laminated coil component and a laminated coil component capable of suppressing the occurrence of defective products by suppressing the collapse of coil conductors during lamination.

According to one aspect of the present invention, there is provided a method for manufacturing a laminated coil component, in which a laminated coil component is manufactured by laminating insulator sheets in order on which conductors having predetermined patterns are formed. The insulator sheets are laminated such that a distance in a lamination direction between a first lead-out conductor laminated first and a first coil conductor laminated next is larger than a distance in the lamination direction between a second lead-out conductor laminated last and a second coil conductor laminated immediately before the second lead-out conductor.

The laminated coil component includes the first coil conductor laminated next to the first lead-out conductor laminated first. In addition, the laminated coil component includes the second coil conductor laminated immediately before the second lead-out conductor laminated last. The first coil conductor is a portion that is likely to be affected by the first lead-out conductor during lamination. The second coil conductor is a portion that is less likely to be affected by the second lead-out conductor during lamination. On the other hand, the insulator sheets are laminated such that the distance between the first lead-out conductor and the first coil conductor in the lamination direction is larger than the distance between the second lead-out conductor and the second coil conductor in the lamination direction. Accordingly, during lamination, since the first coil conductor is spaced apart from the first lead-out conductor, the first coil conductor can be less likely to be affected by the first lead-out conductor. As described above, since the collapse of the coil conductors during lamination is suppressed, the occurrence of defective products can be suppressed.

The insulator sheets may be laminated such that a distance between the first coil conductor and a third coil conductor laminated next to the first coil conductor is smaller than the distance between the first lead-out conductor and the first coil conductor. Since the first coil conductor is spaced apart from the first lead-out conductor by more than the distance between the coil conductors, the first coil conductor can be less likely to be affected by the first lead-out conductor.

According to one aspect of the present invention, there is provided a laminated coil component including: an element body; a coil unit formed by laminating a plurality of coil conductors having predetermined patterns in a lamination direction inside the element body; and a first lead-out conductor and a second lead-out conductor connected to the coil unit inside the element body, and exposed from the element body. The coil unit includes a first coil conductor adjacent to the first lead-out conductor in the lamination direction, and a second coil conductor adjacent to the second lead-out conductor in the lamination direction. A distance between the first lead-out conductor and the first coil conductor in the lamination direction is larger than a distance between the second lead-out conductor and the second coil conductor in the lamination direction.

According to the laminated coil component, the same actions and effects as those of the method for manufacturing a laminated coil component described above can be obtained.

According to the present invention, it is possible to provide the method for manufacturing a laminated coil component and the laminated coil component capable of suppressing the occurrence of defective products by suppressing the collapse of the coil conductors during lamination.

### BRIEF DESCRIPTION OF THE DRAWINGS

FIG. 1 is a perspective view of a laminated coil component in the present embodiment.

FIG. 2 is a schematic cross-sectional view of the laminated coil component shown in FIG. 1.

FIG. 3 is an unfolded view when the laminated coil component shown in FIG. 1 is disassembled and each layer is viewed in a lamination direction.

FIG. 4 is a process diagram showing a method for manufacturing a laminated coil component according to the present embodiment.

FIG. 5A is a schematic cross-sectional view showing the state of an element body before firing in a lamination step, and FIG. 5B is a schematic cross-sectional view showing the state of the element body after firing in the lamination step.

FIG. 6 is a photograph showing a cross-section of the element body after firing.

FIGS. 7A and 7B are schematic views of an embodiment and a comparative example.

### DETAILED DESCRIPTION

Hereinafter, an embodiment of the present invention will be described in detail with reference to the accompanying drawings. In the description of the drawings, the same reference signs will be used for the same or equivalent elements, and duplicate descriptions will be omitted.

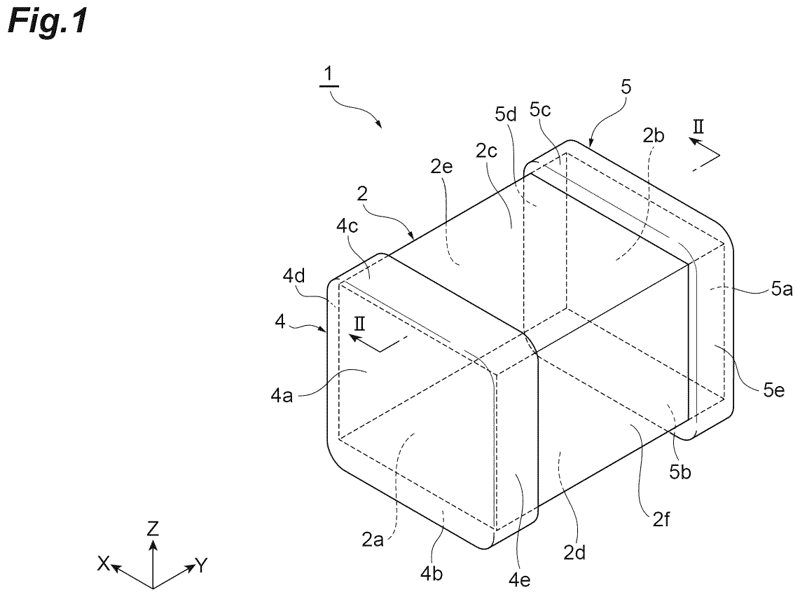

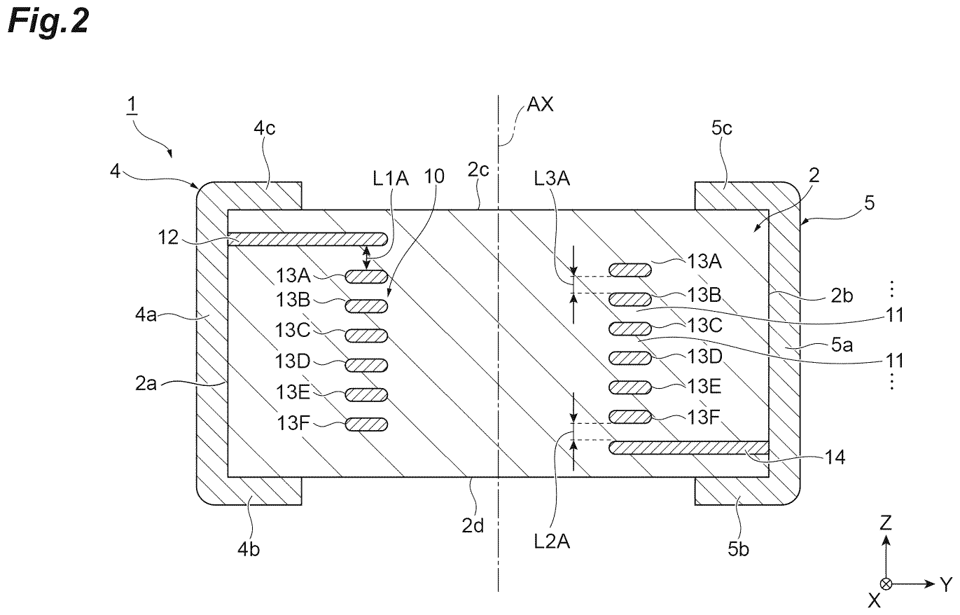

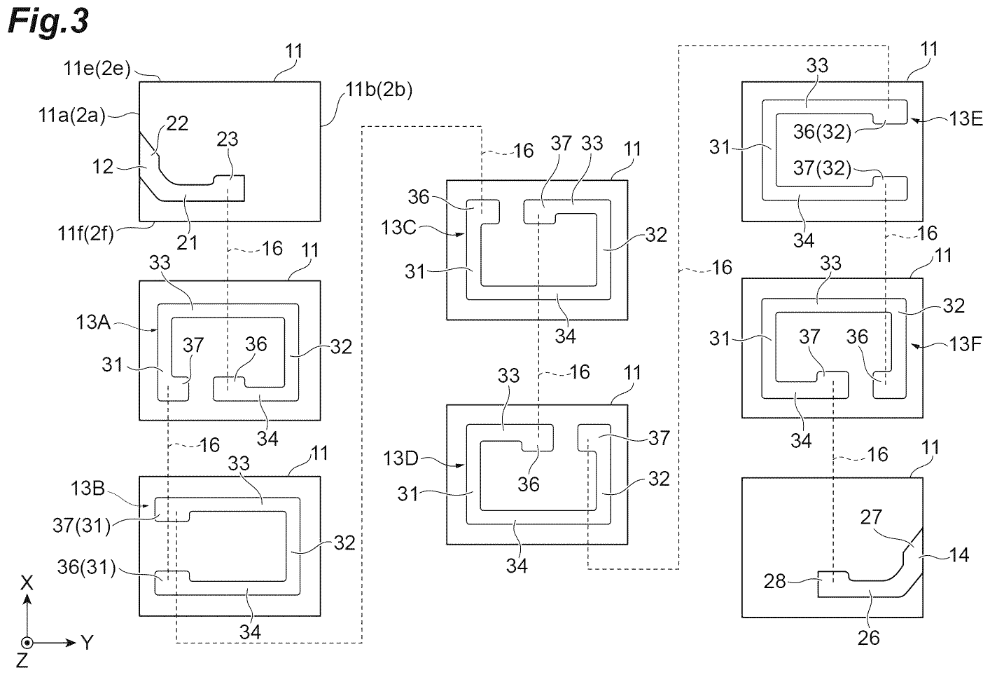

First, a schematic configuration of a laminated coil component 1 in the present embodiment will be described with reference to FIGS. 1 to 3. FIG. 1 is a perspective view of the laminated coil component 1 in the present embodiment. FIG. 2 is a schematic cross-sectional view of the laminated coil component of FIG. 1. FIG. 3 is an unfolded view when the laminated coil component 1 shown in FIG. 1 is disassembled and each layer is viewed in a lamination direction. An X-axis direction, a Y-axis direction, and a Z-axis direction are directions intersecting each other. The laminated coil component in the present embodiment is formed by laminating a plurality of layers in the Z-axis direction. The layers are integrated to such an extent that boundaries therebetween cannot be visually recognized. In the present embodiment, the X-axis direction, the Y-axis direction, and the Z-axis direction are orthogonal to each other. Although not particularly limited, in the present embodiment, the Z-axis direction corresponds to the “lamination direction” in the claims.

An element body 2 has a rectangular parallelepiped shape. The element body 2 has, as outer surfaces, a pair of an end surface 2a and an end surface 2b facing each other in the Y-axis direction, and four side surfaces 2c, 2d, 2e, and 2f extending in a facing direction of the pair of end surfaces 2a and 2b so as to connect the pair of end surfaces 2a and 2b. The side surfaces 2c and 2d face each other in the Z-axis direction. The side surfaces 2e and 2f face each other in the X-axis direction. The side surface 2d is defined as, for example, a surface facing another electronic device (not shown) (for example, a circuit substrate or electronic component) when the laminated coil component 1 is mounted on the other electronic device.

The facing direction of the end surfaces 2a and 2b, a facing direction of the side surfaces 2c and 2d, and a facing direction of the side surfaces 2e and 2f are substantially orthogonal to each other. Incidentally, examples of the rectangular parallelepiped shape include a rectangular parallelepiped shape in which corners and edges are chamfered and a rectangular parallelepiped shape in which corners and edges are rounded.

As shown in FIG. 2, a coil unit 10, a lead-out conductor 12 (first lead-out conductor), and a lead-out conductor 14 (second lead-out conductor) are provided inside the element body 2. The coil unit 10 is formed by electrically connecting a plurality of coil conductors 13A, 13B, 13C, 13D, 13E, and 13F via through-holes. A central axis AX of the coil unit 10 extends in the Z-axis direction. The lead-out conductor 12 is connected to the coil unit 10 inside the element body 2, and is exposed on the end surface 2a. The lead-out conductor 14 is connected to the coil unit 10 inside the element body 2, and is exposed on the end surface 2b.

The element body 2 is formed by laminating a plurality of insulator layers 11, the plurality of coil conductors 13A, 13B, 13C, 13D, 13E, and 13F, and the lead-out conductors 12 and 14. The insulator layers 11 are laminated in the Z-axis direction. Hereinafter, the facing direction of the side surfaces 2c and 2d may be referred to as the “lamination direction”. Incidentally, a side surface 2c side in the lamination direction may be referred to as “top”, and a side surface 2d side in the lamination direction may be referred to as “bottom”, but are terms used to specify a positional relationship between the layers, and do not limit an up-down direction in a manufacturing state or usage state. Each of the insulator layers 11 has a substantially rectangular shape when viewed in the lamination direction (refer to FIG. 3).

The coil conductors 13A, 13B, 13C, 13D, 13E, and 13F and the lead-out conductors 12 and 14 are disposed spaced apart from each other in the lamination direction. The insulator layers 11 are disposed between the coil conductors 13A, 13B, 13C, 13D, 13E, and 13F and the lead-out conductors 12 and 14. The coil conductors 13A, 13B, 13C, 13D, 13E, and 13F and the lead-out conductors 12 and 14 have substantially the same thickness in the lamination direction. The coil conductors 13A, 13B, 13C, 13D, 13E, and 13F and the lead-out conductors 12 and 14 are disposed to overlap each other in the lamination direction with the insulator layers 11 sandwiched therebetween. In the present embodiment, the lead-out conductor 12, the coil conductors 13A, 13B, 13C, 13D, 13E, and 13F, and the lead-out conductor 14 are laminated in order from the top.

As the material of each of the insulator layers 11, an optimum material may be adopted according to the application of the laminated coil component 1. For example, when the laminated coil component 1 is a laminated ceramic coil, each of the insulator layers 11 is composed of a sintered body of glass ceramics containing Al, Zr, Ti, and the like. For example, when the laminated coil component 1 is a laminated ferrite coil, each of the insulator layers 11 may be a sintered body of ceramic green sheets containing ferrite materials such as Fe, Mn, and Zn. For example, when the laminated coil component 1 is a chip bead, each of the insulator layers 11 may be a sintered body of ceramic green sheets containing ferrite materials such as MnFe₂O₄ and ZnFe₂O₄.

As shown in FIG. 1, an external electrode 4 is disposed on an end surface 2a side of the element body 2, and an external electrode 5 is disposed on an end surface 2b side of the element body 2. Namely, the external electrodes 4 and 5 are located spaced apart from each other in the facing direction of the pair of end surfaces 2a and 2b. Each of the external electrodes 4 and 5 contains a conductive material (for example, Ag, Pd, or the like). Each of the external electrodes 4 and 5 is configured as a sintered body of conductive paste containing conductive metal powder (for example, Ag powder, Pd powder, or the like) and glass frits. A plating layer is formed on a surface of each of the external electrodes 4 and 5 by performing electroplating thereon. For example, Ni, Sn, or the like is used as the electroplating.

The external electrode 4 includes five electrode portions that are an electrode portion 4a located on the end surface 2a, an electrode portion 4b located on the side surface 2d, an electrode portion 4c located on the side surface 2c, an electrode portion 4d located on the side surface 2e, and an electrode portion 4e located on the side surface 2f. The electrode portion 4a covers the entirety of the end surface 2a. The electrode portion 4b covers a part of the side surface 2d. The electrode portion 4c covers a part of the side surface 2c. The electrode portion 4d covers a part of the side surface 2e. The electrode portion 4e covers a part of the side surface 2f. The five electrode portions 4a, 4b, 4c, 4d, and 4e are integrally formed.

The external electrode 5 includes five electrode portions that are an electrode portion 5a located on the end surface 2b, an electrode portion 5b located on the side surface 2d, an electrode portion 5c located on the side surface 2c, an electrode portion 5d located on the side surface 2e, and an electrode portion 5e located on the side surface 2f. The electrode portion 5a covers the entirety of the end surface 2b. The electrode portion 5b covers a part of the side surface 2d. The electrode portion 5c covers a part of the side surface 2c. The electrode portion 5d covers a part of the side surface 2e. The electrode portion 5e covers a part of the side surface 2f. The five electrode portions 5a, 5b, 5c, 5d, and 5e are integrally formed.

Next, a configuration of each of the coil conductors 13A, 13B, 13C, 13D, 13E, and 13F and the lead-out conductors 12 and 14 will be described in detail with reference to FIG. 3. As shown in FIG. 3, each of the insulator layers 11 includes edge portions 11a, 11b, 11e, and 11f. The edge portion 11a is formed at a position corresponding to the end surface 2a. The edge portion 11b is formed at a position corresponding to the end surface 2b. The edge portion 11e is formed at a position corresponding to the side surface 2e. The edge portion 11f is formed at a position corresponding to the side surface 2f. Incidentally, the reference signs for the edge portions 11a, 11b, 11e, and 11f are formed only on the insulator layer 11 of the lead-out conductor 12; however, the other insulator layers 11 include the same edge portions 11a, 11b, 11 e, and 11f.

The lead-out conductor 12 includes a side portion 21, a lead-out side portion 22, and a pad portion 23. The side portion 21 extends along the edge portion 11f on an edge portion 11f (side surface 2f) side on a negative side of the X-axis direction. The side portion 21 is provided on an edge portion 11a (end surface 2a) side on a negative side of the Y-axis direction. The lead-out side portion 22 extends from an end portion of the side portion 21 on the negative side of the Y-axis direction to the edge portion Ila. The pad portion 23 forms a rectangular shape wider than a line width of the side portion 21, at an end portion of the side portion 21 on a positive side of the Y-axis direction.

The lead-out conductor 14 includes a side portion 26, a lead-out side portion 27, and a pad portion 28. The side portion 26 extends along the edge portion 11f on the edge portion 11f (side surface 2f) side on the negative side of the X-axis direction. The side portion 26 is provided on an edge portion 11b (end surface 2b) side on the positive side of the Y-axis direction. The lead-out side portion 27 extends from an end portion of the side portion 26 on the positive side of the Y-axis direction to the edge portion 11b. The pad portion 28 forms a rectangular shape wider than a line width of the side portion 26, at an end portion of the side portion 26 on the negative side of the Y-axis direction.

Each of the coil conductors 13A, 13B, 13C, 13D, 13E, and 13F includes side portions 31, 32, 33, and 34 and a pair of pad portions 36 and 37. The pad portion 36 forms a rectangular shape wider than a line width of each of the side portions, and is electrically connected to the pad portion of the conductor of the insulator layer 11 located one stage higher, via a through-hole conductor 16. The pad portion 37 forms a rectangular shape wider than the line width of each of the side portions, and is electrically connected to the pad portion of the conductor of the insulator layer 11 located one stage lower, via the through-hole conductor 16.

The side portion 31 extends along the edge portion 11a on the edge portion 11a (end surface 2a) side on the negative side of the Y-axis direction. The side portion 32 extends along the edge portion 11b on the edge portion 11b (end surface 2b) side on the positive side of the Y-axis direction. The side portion 33 extends along the edge portion 11e on an edge portion 11e (side surface 2e) side on the positive side of the X-axis direction. The side portion 34 extends along the edge portion 11f on the edge portion 11f (side surface 2f) side on the negative side of the X-axis direction. End portions of the side portions 31 and 32 on the positive side of the X-axis direction are connected to end portions of the side portion 33 in the Y-axis direction. End portions of the side portions 31 and 32 on the negative side of the X-axis direction are connected to end portions of the side portion 34 in the Y-axis direction. A conductor pattern having a substantially rectangular annular shape is formed by four side portions 31, 32, 33, and 34. In the conductor pattern, the conductor pattern is interrupted and the side portion is omitted in a region between the pad portion 36 and the pad portion 37.

The coil conductor 13A (first coil conductor) is adjacent to the lead-out conductor 12 on the upper side in the Z-axis direction. The coil conductor 13A includes the pad portion 36 at substantially the center position of the side portion 34 in the X-axis direction, and includes the pad portion 37 at an end portion of the side portion 31 on the negative side of the Y-axis direction.

The coil conductor 13B (third coil conductor) is adjacent to the coil conductor 13A on a side opposite to the lead-out conductor 12 in the Z-axis direction. The coil conductor 13B includes the pad portion 36 at an end portion of the side portion 34 on the negative side of the Y-axis direction, and includes the pad portion 37 at an end portion of the side portion 33 on the negative side of the Y-axis direction. Incidentally, the pad portion 36 includes a portion protruding from the side portion 34 to the positive side in the X-axis direction. The pad portion 37 includes a portion protruding from the side portion 33 to the negative side in the X-axis direction. Therefore, the protruding portions of the pad portions 36 and 37 function as the side portion 31.

The coil conductor 13C is adjacent to the coil conductor 13B on the upper side in the Z-axis direction. The coil conductor 13C includes the pad portion 36 at an end portion of the side portion 31 on the positive side of the X-axis direction, and includes the pad portion 37 at substantially the center position of the side portion 33 in the Y-axis direction. The coil conductor 13D is adjacent to the coil conductor 13C on the upper side in the Z-axis direction. The coil conductor 13D includes the pad portion 37 at an end portion of the side portion 32 on the positive side of the X-axis direction, and includes the pad portion 36 at substantially the center position of the side portion 33 in the Y-axis direction.

The coil conductor 13E is adjacent to the coil conductor 13F on a side opposite to the lead-out conductor 14 in the Z-axis direction. The coil conductor 13E includes the pad portion 37 at an end portion of the side portion 34 on the positive side of the Y-axis direction, and includes the pad portion 36 at an end portion of the side portion 33 on the positive side of the Y-axis direction. Incidentally, the pad portion 37 includes a portion protruding from the side portion 34 to the positive side in the X-axis direction. The pad portion 36 includes a portion protruding from the side portion 33 to the negative side in the X-axis direction. Therefore, the protruding portions of the pad portions 36 and 37 function as the side portion 32.

The coil conductor 13F (second coil conductor) is adjacent to the lead-out conductor 14 on the lower side in the Z-axis direction. The coil conductor 13F includes the pad portion 37 at substantially the center position of the side portion 34 in the Y-axis direction, and includes the pad portion 36 at an end portion of the side portion 32 on the negative side of the X-axis direction.

As shown in FIG. 2, a distance L1A between the lead-out conductor 12 and the coil conductor 13A in the Z-axis direction (lamination direction) is larger than a distance L2A between the lead-out conductor 14 and the coil conductor 13F in the Z-axis direction. In addition, a distance L3A between the coil conductor 13A and the coil conductor 13B is smaller than the distance L1A between the lead-out conductor 12 and the coil conductor 13A. Incidentally, a distance between each of the coil conductors 13A, 13B, 13C, 13D, 13E, and 13F is equal to the distance L3A. In addition, the distance L3A may be equal to the distance L2A. However, the relationship between the distance L3A and the distance L2A is not particularly limited, and the distance L3A may be larger or smaller than the distance L2A.

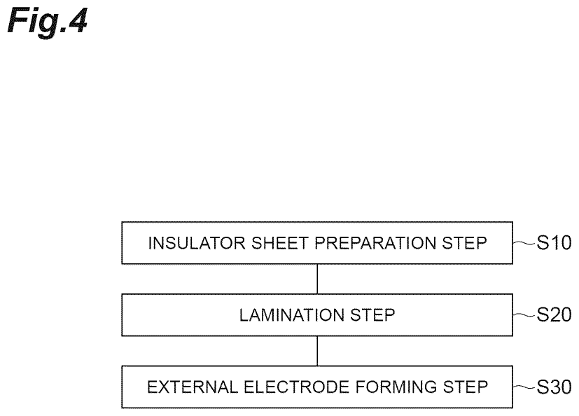

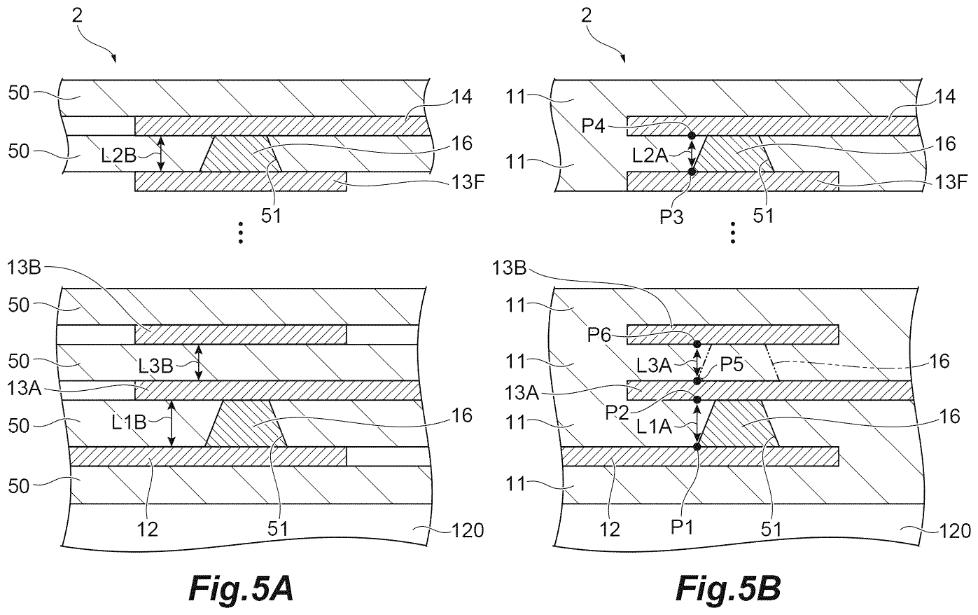

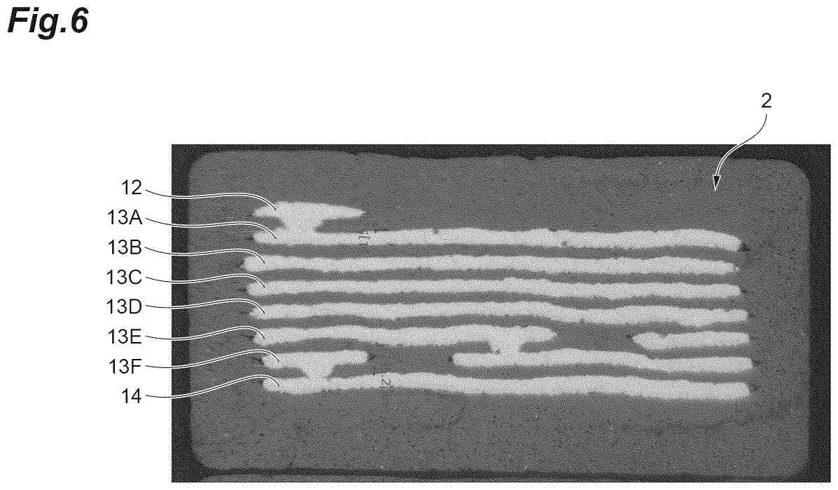

Next, a method for manufacturing the laminated coil component 1 according to the present embodiment will be described with reference to FIGS. 4 to 6. FIG. 4 is a process diagram showing the method for manufacturing the laminated coil component 1 according to the present embodiment. FIG. 5A is a schematic cross-sectional view showing the state of the element body 2 before firing in a lamination step. FIG. 5B is a schematic cross-sectional view showing the state of the element body 2 after firing in the lamination step. FIG. 6 is a photograph showing a cross-section of the element body 2 after firing.

As shown in FIG. 4, first, an insulator sheet preparation step of preparing insulator sheets 50 on which conductors having predetermined patterns are formed is executed (step S10). The insulator sheets 50 (refer to FIG. 5A) are sheet members that become the insulator layers 11 after firing. The conductor patterns of the conductors 12, 13A, 13B, 13C, 13D, 13E, 13F, and 14 shown in FIG. 3 are formed on the insulator sheets 50. In addition, through-holes 51 formed in the insulator sheets 50 are filled with a paste for forming the through-hole conductor 16.

Next, the lamination step of forming the element body 2 by laminating a plurality of the insulator sheets 50 is executed (step S20). As shown in FIG. 5A, in the lamination step S20, the insulator sheets 50 are laminated in order from the insulator sheet 50 on the upper side on which the conductor is formed. Namely, the insulator sheet 50 of the lead-out conductor 12, the insulator sheet 50 of the coil conductor 13A, the insulator sheet 50 of the coil conductor 13B, the insulator sheet 50 of the coil conductor 13C, the insulator sheet 50 of the coil conductor 13D, the insulator sheet 50 of the coil conductor 13E, the insulator sheet 50 of the coil conductor 13F, and the insulator sheet 50 of the lead-out conductor 14 are laminated in order with respect to a base member 120. Incidentally, the through-hole conductor 16 is formed to become thinner as the through-hole conductor 16 extends from the lead-out conductor 12 on the upper side toward the lead-out conductor 14 on the lower side. In the lamination step S20, the lead-out conductor 12 on the upper side is disposed on the lower side, and the lead-out conductor 14 on the lower side is disposed on the upper side. Therefore, in the lamination step S20, the through-hole conductor 16 is disposed to become thinner as the through-hole conductor 16 extends toward the upper side.

The insulator sheets 50 are laminated such that a distance L1B in the lamination direction between the lead-out conductor 12 laminated first and the coil conductor 13A laminated next is larger than a distance L2B in the lamination direction between the lead-out conductor 14 laminated last and the coil conductor 13F laminated immediately before the lead-out conductor 14. In addition, the insulator sheets 50 are laminated such that a distance L3B between the coil conductor 13A and the coil conductor 13B laminated next to the coil conductor 13A is smaller than the distance L1B between the lead-out conductor 12 and the coil conductor 13A. Incidentally, the distance between each of the conductors can be increased or decreased, for example, by adjusting the thickness of the insulator sheets 50 or the material of the insulator sheets 50.

Here, the insulator sheets 50 and each of the conductors before firing shown in FIG. 5A are formed in a planar shape without bending. On the other hand, as shown in FIG. 6, in the element body 2 after firing, the insulator sheets 50 are integrated with each other, and each of the conductors is bent. For this reason, as shown in FIG. 5B, distances between the conductors in the element body 2 after firing are measured as follows. Specifically, a large-diameter portion of the through-hole conductor 16 on a main surface of the lead-out conductor 12 is referred to as a measurement point P1, and a position on a main surface of the coil conductor 13A, the position corresponding to the measurement point P1 in the lamination direction, is referred to as a measurement point P2. In this case, a distance between the measurement point P1 and the measurement point P2 becomes the distance L1A between the lead-out conductor 12 and the coil conductor 13A after firing. A large-diameter portion of the through-hole conductor 16 on a main surface of the coil conductor 13F is referred to as a measurement point P3, and a position on a main surface of the lead-out conductor 14, the position corresponding to the measurement point P3 in the lamination direction, is referred to as a measurement point P4. In this case, a distance between the measurement point P3 and the measurement point P4 becomes the distance L2A between the lead-out conductor 14 and the coil conductor 13F after firing. A large-diameter portion of the through-hole conductor 16 on a main surface of the coil conductor 13A is referred to as a measurement point P5, and a position on a main surface of the coil conductor 13B, the position corresponding to the measurement point P5 in the lamination direction, is referred to as a measurement point P6. In this case, a distance between the measurement point P5 and the measurement point P6 becomes the distance L3A between the coil conductor 13A and the coil conductor 13B after firing.

Next, an external electrode forming step of forming the external electrodes 4 and 5 on the element body 2 is executed (step S30). Accordingly, the laminated coil component 1 is completed.

Next, actions and effects of the laminated coil component 1 according to the present embodiment will be described.

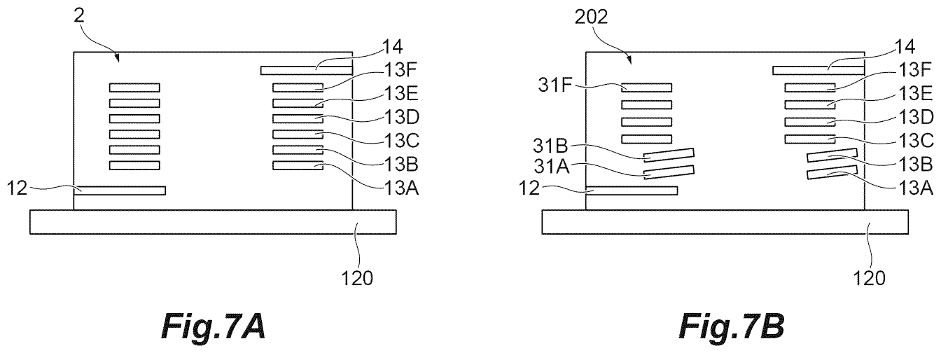

First, an element body 202 of a laminated coil component according to a comparative example will be described with reference to FIG. 7B. In the element body 202, distances between all the conductors 12, 13A, 13B, 13C, 13D, 13E, 13F, and 14 are constant. For this reason, a distance between the lead-out conductor 12 and the coil conductor 13A in the lamination direction is the same as a distance between the lead-out conductor 14 and the coil conductor 13F in the lamination direction. When the lamination of the element body 202 is performed, a lead-out conductor 12 side is pressed against the base member 120. For this reason, the coil conductors 13A and 13B in the vicinity of the lead-out conductor 12 may collapse (shift with respect to the coil conductors of the other layers) due to the influence of the lead-out conductor 12. Specifically, since the lead-out side portion 22 of the lead-out conductor 12 is located on the outer peripheral side of the coil conductor 13A, the coil conductor 13A is pushed out to the inner peripheral side of the coil during lamination, so that a collapse may occur. Accordingly, the desired characteristics of the laminated coil component cannot be obtained, which is a problem.

In the method for manufacturing the laminated coil component 1 according to the present embodiment, in which the laminated coil component 1 is manufactured by laminating the insulator sheets 50 in order on which conductors having predetermined patterns are formed, the insulator sheets 50 are laminated such that the distance L1B in the lamination direction between the lead-out conductor 12 laminated first and the coil conductor 13A laminated next is larger than the distance L2B in the lamination direction between the lead-out conductor 14 laminated last and the coil conductor 13F laminated immediately before the lead-out conductor 14.

The laminated coil component 1 includes the coil conductor 13A laminated next to the lead-out conductor 12 laminated first. In addition, the laminated coil component 1 includes the coil conductor 13F laminated immediately before the lead-out conductor 14 laminated last. The coil conductor 13A is a portion that is likely to be affected by the lead-out conductor 12 during lamination. The coil conductor 13F is a portion that is less likely to be affected by the lead-out conductor 12 during lamination. On the other hand, the insulator sheets 50 are laminated such that the distance L1B between the lead-out conductor 12 and the coil conductor 13A in the lamination direction is larger than the distance between the lead-out conductor 14 and the coil conductor 13F in the lamination direction. Accordingly, during lamination, since the coil conductor 13A is spaced apart from the lead-out conductor 12, the coil conductor 13A can be less likely to be affected by the lead-out conductor 12. As described above, since the collapse of the coil conductors during lamination is suppressed (refer to FIG. 7A), the occurrence of defective products can be suppressed.

The insulator sheets 50 may be laminated such that the distance L3B between the coil conductor 13A and the coil conductor 13B laminated next to the coil conductor 13A is smaller than the distance L1B between the lead-out conductor 12 and the coil conductor 13A. Since the coil conductor 13A is spaced apart from the lead-out conductor 12 by more than the distance L3B between the coil conductors 13A and 13B, the coil conductor 13A can be less likely to be affected by the lead-out conductor 12.

The laminated coil component 1 in the present embodiment includes the element body 2; the coil unit 10 formed by laminating the plurality of coil conductors 13A, 13B, 13C, 13D, 13E, and 13F having the predetermined patterns in the lamination direction inside the element body 2; and the lead-out conductor 12 and the lead-out conductor 14 connected to the coil unit 10 inside the element body 2, and exposed from the element body 2. The coil unit 10 includes the coil conductor 13A adjacent to the lead-out conductor 12 in the lamination direction, and the coil conductor 13F adjacent to the lead-out conductor 14 in the lamination direction. The distance LlA between the lead-out conductor 12 and the coil conductor 13A in the lamination direction is larger than the distance L2A between the lead-out conductor 14 and the coil conductor 13F in the lamination direction.

According to the laminated coil component 1, the same actions and effects as those of the method for manufacturing the laminated coil component 1 described above can be obtained.

The present invention is not limited to the above-described embodiment.

For example, the shapes of the lead-out conductors are not particularly limited, and can be changed as appropriate. In addition, the lamination order of the coil conductors and the like can be changed as appropriate along with changing the configurations of the lead-out conductors.

In addition, the shape of the coil conductor of each layer is not limited to the above-described embodiment, and can be changed as appropriate.

### REFERENCE SIGNS LIST

1: laminated coil component, 2: element body, 10: coil unit, 12: lead-out conductor (first lead-out conductor), 14: lead-out conductor (second lead-out conductor), 13A: coil conductor (first coil conductor), 13F: coil conductor (second coil conductor), 13B: coil conductor (third coil conductor).

What is claimed is:

1. A method for manufacturing a laminated coil component, in which a laminated coil component is manufactured by laminating insulator sheets in order on which conductors having predetermined patterns are formed,
wherein the insulator sheets are laminated such that a distance in a lamination direction between a first lead-out conductor laminated first and a first coil conductor laminated next is larger than a distance in the lamination direction between a second lead-out conductor laminated last and a second coil conductor laminated immediately before the second lead-out conductor.

2. The method for manufacturing a laminated coil component according to claim 1,
wherein the insulator sheets are laminated such that a distance between the first coil conductor and a third coil conductor laminated next to the first coil conductor is smaller than the distance between the first lead-out conductor and the first coil conductor.

3. A laminated coil component comprising:
an element body;
a coil unit formed by laminating a plurality of coil conductors having predetermined patterns in a lamination direction inside the element body; and
a first lead-out conductor and a second lead-out conductor connected to the coil unit inside the element body, and exposed from the element body,
wherein the coil unit includes a first coil conductor adjacent to the first lead-out conductor in the lamination direction, and a second coil conductor adjacent to the second lead-out conductor in the lamination direction, and
a distance between the first lead-out conductor and the first coil conductor in the lamination direction is larger than a distance between the second lead-out conductor and the second coil conductor in the lamination direction.
